(19) United States
(12) Patent Application Publication
(10) Pub. No.: US 2015/0357085 A1
(43) Pub. Date: Dec. 10, 2015

(54) INSULATED ELECTRIC CORD

(71) Applicant: Gripple Limited, Sheffield, South Yorkshire (GB)

(72) Inventor: David Kinsey, Suffolk (GB)

(21) Appl. No.: 14/389,673

(22) PCT Filed: Apr. 11, 2013
(86) PCT No.: PCT/GB2013/000163

§ 371 Date: Sep. 30, 2014

(30) Foreign Application Priority Data
Apr. 16, 2012 (GB) 1206609.8
Apr. 18, 2012 (GB) 1206825.0
Apr. 8, 2013 (GB) 1306282.3

(51) Int. Cl. H01B 7/40; H02G 1/14; H01B 7/04

(52) U.S. Cl. CPC H01B 7/40; H01B 7/04; H02G 1/14

(57) ABSTRACT

An insulated electric cord (10) for suspending an electrical device (100) from a support (104) is disclosed. The insulated electric cord comprises an elongate outer covering arrangement (12) and first and second elongate electrical conductors (14, 16) for electrically connecting the electrical device to wiring of a mains supply of electricity at the support. The first and second elongate electrical conductors are held within the outer covering arrangement and extend longitudinally therethrough, insulated electric cord further includes an elongate load bearing member (20) for connection at a first end portion (12A) thereof to a first non-electrical load bearing connector (106) in the device and for connection at a second opposite end portion (12B) to a second non-electrical load bearing connector (114) at the support. The load bearing member is held within the outer covering arrangement and extends longitudinally therethrough. The outer covering arrangement has an elongate access formation (31) to allow the first and second opposite end portions of the load bearing member to be extracted from the outer covering arrangement via the elongate access formation and connected respectively to the aforesaid load bearing connectors.

This invention relates to insulated electric cords. More particularly, but not exclusively, this invention relates to flexible insulated electric cords. Embodiments of the invention relate to flexible electric cords for supporting loads.

A standard insulated electrical flexible cord comprises conductors to carry the current, insulating material to prevent the conductors coming into electrical contact with one another, and an insulating sheath material to protect the insulating material. Some electric cords can be used to suspend light fittings from ceilings, providing the light fittings do not exceed a maximum weight.

According to one aspect of this invention, there is provided an insulated electric cord comprising an elongate outer covering arrangement, first and second elongate electrical conductors held within the outer covering arrangement and extending longitudinally therethrough, and a load bearing member held within the outer covering arrangement and extending longitudinally therethrough, wherein the outer covering arrangement has an access formation to allow a portion of the load bearing member to be extracted from the outer covering arrangement.

According to another aspect of this invention, there is provided an insulated electric cord for suspending an electrical device from a support, said insulated electric cord comprising an elongate outer covering arrangement, first and second elongate electrical conductors for electrically connecting the electrical device to wiring of a mains supply of electricity at the support, said first and second elongate electrical conductors being held within the outer covering arrangement and extending longitudinally therethrough, an elongate load bearing member for connection at a first end portion thereof to a first non-electrical load bearing connector in the device and for connection at a second opposite end portion to a second non-electrical load bearing connector at the support, the load bearing member being held within the outer covering arrangement and extending longitudinally therethrough, wherein the outer covering arrangement has an access formation to allow the first and second opposite end portions of the load bearing member to be extracted from the outer covering arrangement via the access formation and connected respectively to the aforesaid load bearing connectors.

According to a further aspect of this invention, there is provided a suspension arrangement comprising an insulated electric cord as described above, an electrical device having a first non-electrical load bearing connector, and a support having a second non-electrical load bearing connector, said first and second elongate electrical conductors electrically connecting the electrical device to wiring of a mains supply of electricity at the support, said elongate load bearing member being connected at the first end portion thereof to the first non-electrical load bearing connector in the device and being connected at the second opposite end portion thereof to the second non-electrical load bearing connector at the support, wherein the first and second opposite end portions of the load bearing member extend from the outer covering arrangement via the access formation.

According to another aspect of this invention, there is provided a method of suspending an electrical device from a support using an insulated electric cord as described above, said method comprising electrically connecting the first and second elongate electrical conductors to the electrical device and to a supply of electricity at the support, extracting a first end portion of the load bearing member from the outer covering arrangement via the access formation, effecting a non-electrical connection between a first end portion of the load bearing member and a first load bearing connector in the device, extracting a second opposite end portion of the load bearing member from the outer covering arrangement via the access formation, and effecting a non-electrical connection between a second end portion of the load bearing member and a second load bearing connector at the support.

The insulated electric cord may comprise a flexible insulated electric cord.

The portion of the load bearing member so extracted may be an end portion. The access formation may allow opposite end portions of the load bearing member to be extracted from the outer covering arrangement.

The step of extracting the first end portion of the load bearing member from the outer covering arrangement may comprise peeling the first end portion of the load bearing member from the outer covering arrangement via the access formation. The step of extracting the second end portion of the load bearing member from the outer covering arrangement may comprise peeling the second end portion of the load bearing member from the outer covering arrangement via the access formation.

If desired, the extracted load bearing member may be inserted back into the covering arrangement after extraction. This provides the advantage in the embodiments described herein that some of the load bearing member can be hidden away in the covering arrangement if, for example, too much of the load bearing member is extracted.

The access formation may be elongate. The access formation may extend longitudinally along the outer covering arrangement. The access formation may extend substantially the whole length of the outer covering arrangement. In a first embodiment, the access formation may be an elongate opening defined by the elongate outer covering arrangement.

The feature of the access formation extending substantially the whole length of the outer covering arrangement provides the advantages in the embodiments described herein that the manufacturing cost is minimised, and the insulated electric cord can be cut to any desired length.

Alternatively, the access formation may be severable region of the outer covering arrangement. The severable region may be thinner than the remainder of the outer covering arrangement, said region extending alongside the load bearing member. The severable region may be configured to allow easy and safe access to the load bearing member. In the embodiment described herein, the severable region is sufficiently wide so as not to affect adversely the overall performance of the outer covering arrangement.

The outer covering arrangement may be flexible. The outer covering arrangement may have a substantially circular cross-sectional end profile.

The insulated electric cord may include a third elongate electrical conductor held within the outer covering arrangement. Each elongate conductor may be embedded in the material of the outer covering arrangement.

The outer covering arrangement may define an elongate cavity extending longitudinally through the outer covering arrangement. In the first embodiment, the elongate cavity may have a substantially circular cross-sectional end profile. The load bearing member may extend through the elongate cavity. The access formation may be an elongate opening of the cavity to allow said portion of the load bearing member to be removed from the outer covering arrangement.

In the first embodiment, the access formation may include a channel extending from the opening of the cavity to an external surface of the outer covering arrangement. In the first embodiment, the outer covering arrangement may be an elongate insulating sheath.

In a second embodiment, the outer covering arrangement may comprise an outer sleeve and an insulating sheath. The outer sleeve may be provided around the insulating sheath. The outer sleeve may extend substantially the whole length of the insulating sheath. The load bearing member may extend through the opening in the insulating sheath to engage the sleeve.

The portion of the outer sleeve in engagement with the load bearing member may be weaker than the remainder of the sleeve. The portion of the sleeve in engagement with the load bearing member may be thinner than the remainder of the sleeve.

The insulating sheath may define at least one elongate space extending longitudinally through the outer covering arrangement. The conductors may be mounted in the, or each, elongate space. In the first embodiment, a single elongate space is defined through the insulating sheath, whereby each of the conductors extends longitudinally through the single elongate space. In the second embodiment, a respective elongate space may be defined in the outer covering arrangement for each conductor, whereby each conductor extends longitudinally through the respective space. The outer covering arrangement may engage around a major proportion of the longitudinally extending perimeter of each conductor.

In the first and second embodiments, the elongate cavity and the, or each, elongate space may be defined in the insulating sheath.

In the first embodiment, the elongate space may have a substantially triangular end profile. Each of the conductors may be provided at a respective apex of the triangle.

In the second embodiment, each elongate space may have a substantially circular end profile.

Each conductor may comprise an elongate electrically conductive core, which may be formed of a metal, such as copper. Each conductor may comprise an elongate insulator extending around the electrically conductive core. The insulator may be formed of a synthetic material, which may be a resilient synthetic material, such as a polymer material. Each insulator may be plastically deformable. The synthetic material may comprise PVC.

The load bearing member may be a wire rope, such as a 7×7 wire rope.

The insulating sheath may be formed of a synthetic material, which may be electrically insulating and may be a resilient synthetic material, such as a polymer material. The insulating sheath may be plastically deformable.

Embodiments of the invention will now be described by way of example only, with reference to the accompanying drawings, in which:

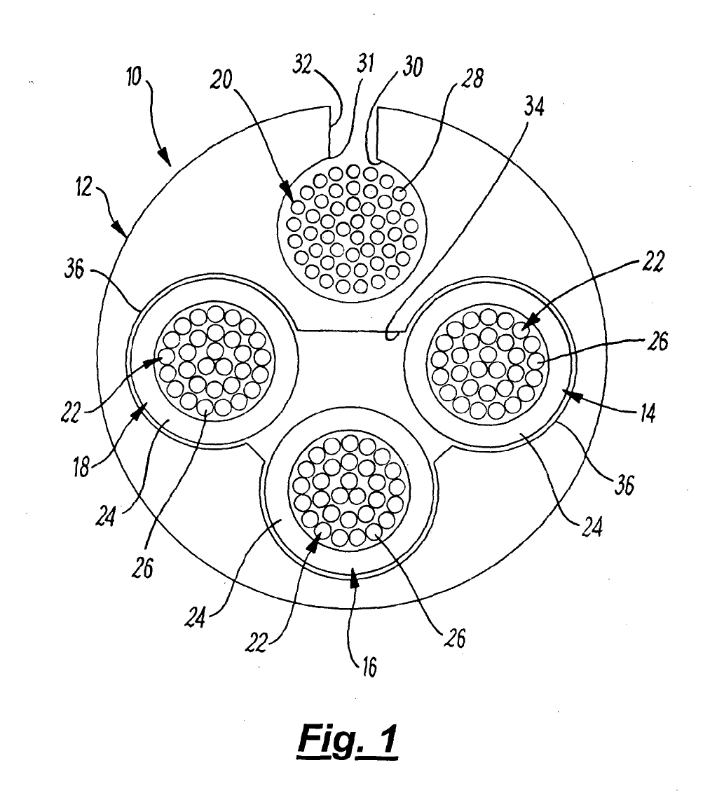

FIG. 1 is a cross-sectional end view of a first embodiment of an electrically insulating cord;

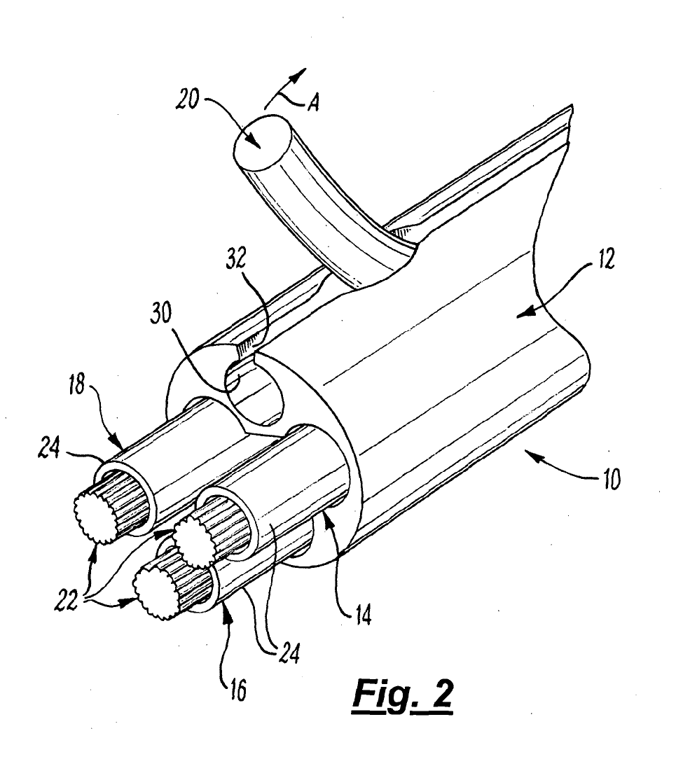

FIG. 2 is a perspective view of an end region of the electrically insulating cord shown in FIG. 1;

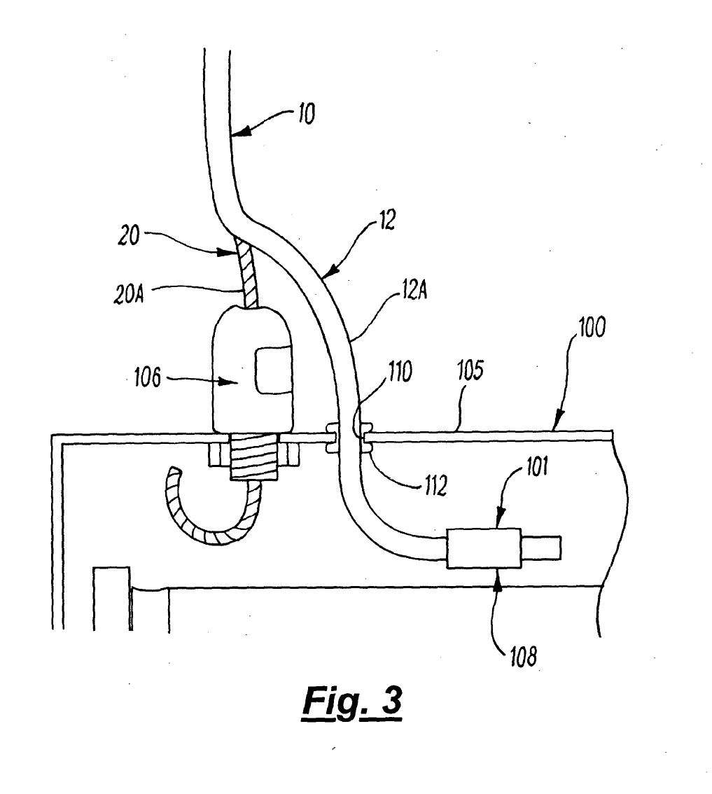

FIG. 3 shows the connection of one end region of the electrically insulating cord to a fixture;

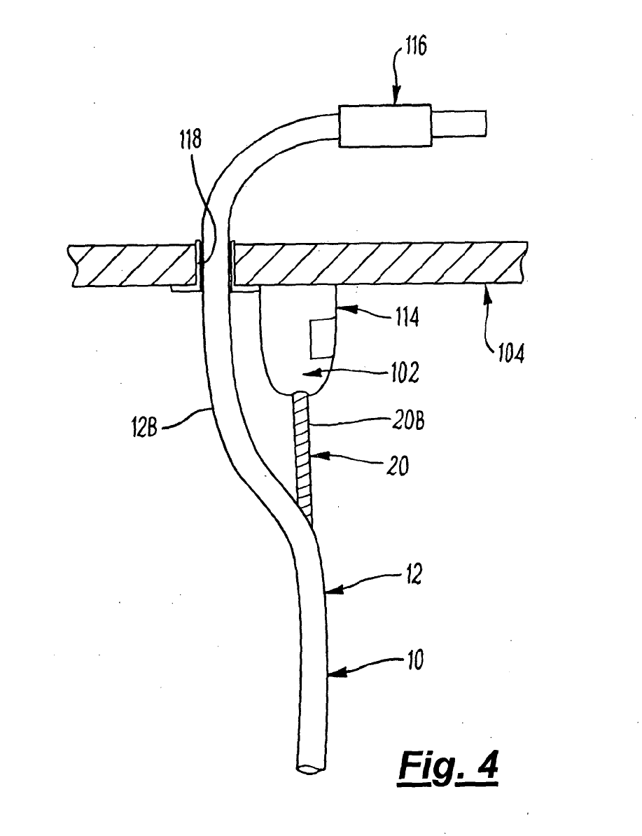

FIG. 4 shows the connection of the opposite end region of the insulating cord to a connection arrangement in a ceiling; and

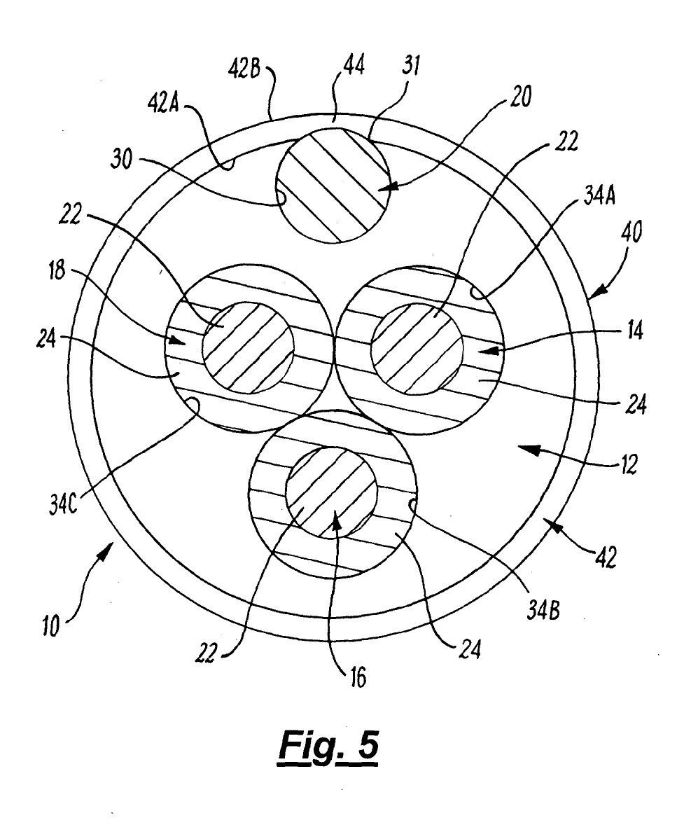

FIG. 5 is a cross-sectional end view of a second embodiment of an electrically insulating cord.

A first embodiment of a flexible insulating electric cord 10 is shown in FIGS. 1 to 4 of the drawings, and comprises a flexible elongate outer covering arrangement in the form of an insulating sheath 12 formed of a suitable plastically deformable synthetic material, such as PVC. The flexible electrically insulating cord 10 further includes three electrically insulating elongate conductors 14, 16, 18 embedded within the flexible insulating sheath 12, and an elongate load bearing member 20, also embedded within the insulating sheath 12. The conductors 14, 16, 18 and the load bearing member 20 extend longitudinally through the whole length of the insulating sheath 12.

Each of the elongate conductors 14, 16, 18 comprises an elongate electrically conductive core 22 and an insulator 24 surrounding the electrically conductive core 22. The core 12 of each of the conductors 14, 16, 18 comprises a plurality of strands 26 of an electrically conductive material, such as copper. The elongate strands 26 are arranged around each other to form a wire.

The load bearing member 20 comprises a plurality of elongate strands 28 of a load bearing material, such as steel. The elongate strands 28 are arranged around each other to form a wire.

The insulating sheath 12 defines an elongate cavity 30 in which the load bearing member 20 is held. The elongate cavity 30 extends longitudinally through the whole length of the insulating sheath 12. As can be seen from FIG. 1, the elongate cavity 30 has a substantially circular cross-sectional end profile.

The insulating sheath 12 has an access formation in the form of an elongate opening 31 in the insulating sheath 12 for the cavity 30 which extends the longitudinally through the whole length of the insulating sheath 12. An elongate channel 32 extends from the opening 31 to the external surface of the insulating sheath 12. The elongate opening 31 communicates with the elongate cavity 30, and allows the end portions of the load bearing member 20 to be extracted from the cavity 30 in which the load bearing member 20 is held, and peeled outwardly from the insulating sheath 12, as shown by the arrow A in FIG. 2

The insulating sheath 12 defines an elongate space 34 extending the length of the insulating sheath. The conductors 14, 16, 18 are provided within the elongate space 34.

The elongate space 34 is of a generally triangular configuration having part circular elongate recesses 36 at each apex of the triangle. The conductors 14, 16, 18 are held within a respective one of the recesses 36. As can be seen, each of the recesses extends around a major portion of the longitudinally extending perimeter of the respective conductors 14, 16, 18, thereby holding the conductors 14, 16, 18 in position.

FIG. 3 shows the connection of one end region of the electrically insulating cord 10 to a first connection assembly 101 in an electrical device in the form of a fixture, such as a light fitting 100. FIG. 4 shows the connection of the opposite end region of the electrically insulating cord 10 to a second connection assembly 102 in a support, such as a ceiling 104.

Referring to FIG. 3, the upper region of the light fitting 100 is shown, which comprises a housing 105. The first connection assembly 101 comprises a mechanical connector in the form of a first load bearing connector in the form of a first gripping device 106, suitable for gripping the load bearing member 20. The first gripping device 106 is mounted on the outside of the housing 105.

In FIG. 3, a lower end portion 20A has been extracted from a lower end region 12A of the insulating sheath 12. The first gripping device 106 has suitable internal gripping components for gripping the extracted lower end portion 20A of the load bearing member 20 and to fasten the light fitting 100 securely to the load bearing member 20.

The first connection assembly 101 in the light fitting 100 also has a first electrical connection arrangement generally designated 108 having electrical terminals to connect to the elongate electrical conductors 14, 16, 18. The first electrical connection arrangement 108 can be any suitable electrical connection arrangement known in the art. The lower end portion 12A of the insulating sheath no longer has the load bearing member 20 extending therethrough, and can be arranged within the first electrical connection arrangement 108 in a manner in which each of the conductors is connected to a respective electrical terminal.

The electrically insulating cord 10 extends through an aperture 110 in the housing 105. An O-ring seal 112 is mounted in the aperture 110 to seal against the insulating sheath 12. As shown in the drawings, the insulating sheath 12 has a cross-sectional end profile that is substantially circular. In the embodiment described herein, this provides the advantage that the O-ring seal 112 can seal fully against the insulating sheath 12, thereby preventing the ingress of water and insects.

Referring to FIG. 4, the upper end region of the electrical insulating cord 10 is shown, which is connected to the second connection assembly 102 at the ceiling 104. The connection assembly 102 comprises a mechanical connector in the form of a second load bearing connector in the form of a second gripping device 114 mounted on the ceiling 104, and extending downwardly therefrom. The second gripping device 114 is the same as the first gripping device 106.

The second connection assembly 102 further includes a second electrical connection arrangement 116, which is the same as the first electrical connection arrangement 108.

In FIG. 4, an upper end portion 20B of the load bearing member 20 has been extracted from an upper end region 12B of the insulating sheath 12, and is inserted into the second gripping device 114 to be gripped thereby.

The second connection assembly 102 also has a second electrical connection arrangement generally designated 116 having electrical terminals to connect to the elongate electrical conductors 14, 16, 18. The second electrical connection arrangement 116 can be the same as the first electrical connection arrangement 108.

The upper end portion 12B of the insulating sheath 12 no longer has the load bearing member 20 extending therethorough, and can pass through an aperture 118 in the ceiling to be arranged within the second electrical connection arrangement 116 in a manner in which each of the electrical conductors 14, 16, 18 is connected to a respective electrical terminal.

Thus, the light fitting 100 is suspended from the ceiling by the mechanical connection between the extracted portions 20A, 20B, and provides electrical connection between the first and second electrical connection arrangements 108, 116, thereby providing a supply of electricity to the light fitting 100.

FIG. 5 shows a second embodiment of the electrically insulating cord 10, which includes such modifications. The second embodiment of the electrically insulating cord 10 shown in FIG. 5 is similar to the first embodiment, having many of the same features as the first embodiment, these features having been designated with the same reference numerals as in FIGS. 1 to 4.

The second embodiment differs from the first embodiment in that the second embodiment has an outer covering arrangement 40 comprising the insulating sheath 12 and an outer sleeve 42, wherein the outer sleeve 42 extends around the insulating sheath 12. The outer sleeve 42 has an inner surface 42A in engagement with the insulating sheath 12, and an outer surface 42B

The insulating sheath 12 defines the elongate cavity 30 in which the load bearing member 20 is tightly held. The insulating sheath 12 also defines three elongate cylindrical spaces 34A, 34B and 34C in each of which a respective one of the conductors 14, 16, 18 is tightly held.

The outer covering arrangement 40 has an access formation in the form of an opening 31 in the insulating sheath 12 for the cavity 30, and a severable region 44 of the outer sleeve 42, the severable region 44 being thinner than the remainder of the outer sleeve 42. The severable region 44 of the outer sleeve 42 extends longitudinally along the load bearing member 20 in engagement therewith.

The opening 31 opens onto the inner surface 42A of the outer sleeve 42, so that the load bearing member 20 protrudes out of the insulating sheath 12 through the opening 31 to engage the outer sleeve 42. As can be seen from FIG. 5, the region 44 of the outer sleeve 42 along the opening 31 is thinner than the thickness of the remainder of the outer sleeve 42. This thinner region 44 of the outer sleeve 42 is thereby weaker than the remainder of the outer sleeve 42.

The end portions of the load bearing member 20 can be peeled outwardly from the insulating sheath 12, thereby splitting the outer sleeve 42 at the region 44. This allows the end portions of the load bearing member to be extracted from the cavity 30 to extend through the outer sleeve 42, thereby disposing the end portions of the load bearing member so that they can, for example, be gripped by the first and second gripping devices 106, 114, in the same way as described above.

With the load bearing member 20 held within the insulating sheath 12, the embodiment of the electrically insulating cord 10 described herein provides an aesthetically pleasing product, which is devoid of any external load bearing members.

The embodiment described herein of the electrically insulating cord 10 can be used to suspend light fittings from ceilings where the weight of the light fittings exceeds the maximum weight of light fittings that can be suspended using some of the prior art electrically insulating cords.

In the embodiments described herein, the features of the channel 32 and the severable region 44, allowing the load bearing member 20 to be peeled away from the sheath 12, are advantageous. For example, they provide the advantages that installation of the insulating electric cord 10 is simple, and that any need to use a knife slit the cord 10 along its length is obviated.

Various modifications can be made without departing from the scope of the invention.

1-32. (canceled)

33. An insulated electric cord comprising an elongate outer covering arrangement, first and second elongate electrical conductors held within the outer covering arrangement and extending longitudinally therethrough, and an elongate load bearing member held within the outer covering arrangement and extending longitudinally therethrough, wherein the outer covering arrangement has an elongate access formation configured to allow a portion of the load bearing member to be extracted from the outer covering arrangement.

34. An insulated electric cord according to claim 33, wherein the portion of the load bearing member so extracted is an end portion.

35. An insulated electric cord according to claim 33, for suspending an electrical device from a support, wherein the first and second elongate electrical conductors are provided for electrically connecting the electrical device to wiring of a mains supply of electricity at the support, the elongate load bearing member is provided for connection at a first end portion thereof to a first non-electrical load bearing connector in the device and for connection at a second opposite end portion to a second non-electrical load bearing connector at the support, and wherein the elongate access formation is configured to allow the first and second opposite end portions of the load hearing member to be extracted from the outer covering arrangement via the elongate access formation and connected respectively to the aforesaid load hearing connectors.

36. An insulated electric cord according to claim 33, wherein the access formation extends substantially the whole length of the outer covering arrangement.

37. An insulated electric cord according to claim 33, wherein the access formation is an elongate opening defined in the elongate outer covering arrangement said elongate opening extending alongside the load bearing member.

38. An insulated electric cord according to claim 33, wherein the access formation comprises a region of weakness of the outer covering arrangement, said region extending alongside the load bearing member.

39. An insulated electric cord according to claim 33, wherein each elongate conductor is embedded in the material of the outer covering arrangement.

40. An insulated electric cord according to claim 33, wherein the outer covering arrangement comprises an elongate insulating sheath defining an elongate cavity extending longitudinally through the outer covering arrangement, the load bearing member extending through the elongate cavity.

41. An insulated electric cord according to claim 40, wherein the access formation is an elongate opening of the cavity to allow said portion of the load bearing member to be removed from the outer covering arrangement.

42. An insulated electric cord according to claim 41, wherein the access formation has a channel extending from the opening of the cavity to an external surface of the outer covering arrangement.

43. An insulated electric cord according to claim 40, wherein the outer covering arrangement comprises an elongate outer sleeve provided around the insulating sheath.

44. An insulated electric cord according to claim 43, wherein the access formation is an elongate opening of the cavity to allow said portion of the load bearing member to be removed from the outer covering arrangement, the load bearing member extending through the opening in the insulating sheath to engage the sleeve.

45. An insulated electric cord according to claim 44, wherein the portion of the sleeve in engagement with the load bearing member is thinner than the remainder of the sleeve, whereby said portion of the outer sleeve in engagement with the load bearing member is weaker than the remainder of the sleeve.

46. An insulated electric cord according to claim 40, wherein the insulating sheath defines at least one elongate space extending longitudinally through the outer covering arrangement, the conductors being mounted in the, or each, elongate space.

47. An insulated electric cord according to claim 46, wherein a single elongate space is defined through the insulating sheath, whereby each of the conductors extends longitudinally through the single elongate space.

48. An insulated electric cord according to claim 46, wherein a respective elongate space is defined through the insulating sheath for each conductor, whereby each conductor extends longitudinally through the respective space.

49. A suspension arrangement comprising an insulated electric cord as claimed in claim 33, an electrical device having a first non-electrical load bearing connector, and a support having a second non-electrical load bearing connector, said first and second elongate electrical conductors electrically connecting the electrical device to wiring of a mains supply of electricity at the support, said elongate load bearing member being connected at the first end portion thereof to the first non-electrical load bearing connector in the device and being connected at the second opposite end portion thereof to the second non-electrical load bearing connector at the support, wherein the first and second opposite end portions of the load bearing member extend from the outer covering arrangement via the elongate access formation.

50. A method of suspending an electrical device from a support using an insulated electric cord as claimed in claim 33, said method comprising electrically connecting the first and second elongate electrical conductors to the electrical device and to a supply of electricity at the support, extracting a first end portion of the load bearing member from the outer covering arrangement via the access formation, effecting a non-electrical connection between a first end portion of the load bearing member and a first load bearing connector in the device, extracting a second opposite end portion of the load bearing member from the outer covering arrangement via the access formation, and effecting a non-electrical connection between a second end portion of the load bearing member and a second load bearing connector at the support.

51. A method according to claim 50, wherein the step of extracting the first end portion of the load bearing member from the outer covering arrangement comprises peeling the first end portion of the load bearing member from the outer covering arrangement via the access formation.

52. A method according to claim 50, wherein the step of extracting the second end portion of the load bearing member from the outer covering arrangement comprises peeling the second end portion of the load bearing member from the outer covering arrangement via the access formation.
